(19) United States
(12) Patent Application Publication
(10) Pub. No.: US 2017/0186092 A1
(43) Pub. Date: Jun. 29, 2017

(54) SYSTEM AND METHOD FOR PROVIDING OFFLINE FRAMEWORK FOR BUSINESS SUPPORT

(71) Applicant: Cognizant Technology Solutions India Pvt. Ltd., Chennai (IN)

(72) Inventors: Shyam Sundar Nagarajan, Chennai (IN); Arun Krishnan Nair, Chennai (IN); Chandrashekaran Shanmugam, Chennai (IN)

(21) Appl. No.: 15/080,095

(22) Filed: Mar. 24, 2016

(30) Foreign Application Priority Data
Dec. 29, 2015 (IN) 7031/CHE/2015

(51) Int. Cl. G06Q 40/08

(52) U.S. Cl. CPC G06Q 40/08

(57) ABSTRACT

A system and a method for providing an offline framework for supporting insurance businesses are described. The offline framework analyzes user inputs in association with one or more predefined rules that are invoked from an offline database for performing complex computations and calculations in an offline mode without using an Internet connection. The offline framework being implemented using a portable electronic device.

### FIELD OF THE INVENTION

The present invention relates generally to insurance business management and more particularly it relates to offline framework for supporting insurance businesses.

### BACKGROUND OF THE INVENTION

An insurance business is a complex business of providing monetary protection by an insurance company to an insured party against a risk. The insurance business generally involves numerous transactions and activities in the course of initiating an insurance policy until the issuance of that policy.

At the outset of the insurance industry, and until recently, these transactions and activities have been carried out manually that involved tremendous amount of paper work, and were time consuming. However, with advent of digital technologies like computer, Internet, and smart electronic devices, the insurance companies have been able to reduce paper work and carry out the complex insurance business processes in a much lesser time.

Currently, the insurance companies run their business by using the Internet and web-based solutions. To sell or demonstrate any insurance policy to a consumer or a customer, the agents or representatives of the insurance companies take help of one or more smart electronic devices like smart phones and electronic tablets. These smart electronic devices are aided with one or more electronic applications (e-Applications) that connect through the Internet, to the web servers of the insurance companies and help in performing all kinds of complex insurance computations, calculations and transactions.

The Internet-based solutions used by the insurance companies however, rely on network connectivity and speed of the Internet. Many a time, due to unavailability of the Internet connections, or due to poor network strength, the insurance agents are not able to cater timely and sufficient information to their customers and are bound to conduct several iterations before closing a deal. Subsequently, any ongoing deal between the insurance company and its customers is either delayed too much or gets cancelled, as the customers loose their interest in buying the insurance policies. Further, the traditional approach of using pen and paper to demonstrate any insurance policy for sale cannot be used as all the business rules, policies, algorithms for complex calculations, and other data, reside on the servers and are inaccessible without the Internet connectivity.

In light of the above, there is a need for a system and method to provide insurance business support without requiring an Internet connection. Further, there is a need for a system and method to provide insurance business support via a portable electronic device. Furthermore, there is a need for a system and method for providing an offline framework capable of performing complex computations in absence of Internet connectivity, for supporting insurance businesses.

### SUMMARY OF THE INVENTION

A system and a computer-implemented method for supporting insurance business in an offline mode are provided.

The system for supporting insurance business in an offline mode comprises one or more processors executing program instructions stored in one or more storage devices. At least one processor of the one or more processors configure the dynamic user interface, a database, and an offline framework. The system further comprises a routing layer for providing a link between the dynamic user interface and the offline framework.

The dynamic user interface is configured based on one or more user interface templates, one or more predefined rules, and user preferences. The dynamic user interface receives user inputs from one or more users. The dynamic user interface comprises an HTML templating engine for generating the one or more user interface templates. The dynamic user interface further comprises a validation framework for authorizing one or more users to access the offline framework. The dynamic user interface further comprises a language translation engine for providing language translation support.

The database is configured for storing the one or more user interface templates, the one or more predefined rules, and data pertaining to one or more insurance business products. Further, the offline framework is in synchronization with the dynamic user interface and the offline database.

The offline framework is configured for analyzing the user inputs and invoking the one or more predefined rules for executing one or more complex computations and calculations for insurance business support. The offline framework comprises a rule engine for generating the one or more predefined rules. The offline framework further comprises a product engine for providing the data pertaining to the one or more insurance business products. The offline framework further comprises a data sync framework for providing synchronization between one or more components of the offline framework. The offline framework further comprises a content engine for facilitating digital publication of content in an offline mode.

The computer-implemented method for supporting insurance business in an offline mode, comprises the steps of: executing via one or more processors, program instructions stored in one or more storage devices for: configuring a dynamic user interface based on one or more user interface templates, one or more predefined rules, and user preferences, wherein the dynamic user interface receives user inputs from one or more users; storing in a database the one or more user interface templates, the one or more predefined rules, and data pertaining to one or more insurance business products; and configuring an offline framework in synchronization with the dynamic user interface and the offline database, the offline framework analyzing the user inputs and invoking the one or more predefined rules for executing one or more complex computations and calculations for insurance business support.

In various embodiments of the present invention, each of the one or more user interface templates is unique having one or more menus and one or more input fields for customizing the dynamic user interface. The one or more predefined rules are based on the one or more insurance business products. In one embodiment of the present invention, the one more predefined rules are based on the geographical locations of one or more end-users of the one or more insurance business products.

The database is updated based on any changes occurring in insurance business domain. The database is further updated randomly or after a fixed interval of time.

### BRIEF DESCRIPTION OF THE ACCOMPANYING DRAWINGS

The present invention is described by way of embodiments illustrated in the accompanying drawings wherein:

FIG. 1 is a block diagram of a system providing an offline framework for supporting insurance businesses in accordance with an embodiment of the present invention;

FIG. 2 is a block diagram of an offline user interface in accordance with an embodiment of the present invention;

FIG. 3 is a block diagram illustrating elements of the offline framework in accordance with an embodiment of the present invention;

FIG. 4 is a flowchart illustrating method for providing an offline framework for supporting insurance businesses in accordance with an exemplary embodiment of the present invention;

FIG. 5 is an exemplary screenshot of the offline framework in accordance with an embodiment of the present invention; and

FIG. 6 illustrates an exemplary portable electronic device which can be used to implement various embodiments of the present invention.

### DETAILED DESCRIPTION OF THE INVENTION

A system and a method for providing an offline framework for supporting insurance businesses are described. The invention provides for a system and method that configures an offline framework to support insurance business without requiring an Internet connection. Further, the invention provides for a system and method that configures an offline framework for supporting insurance business support via a portable electronic device. Furthermore, the invention provides for a system and method that configures an offline framework capable of performing complex computations and calculations for supporting insurance businesses.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

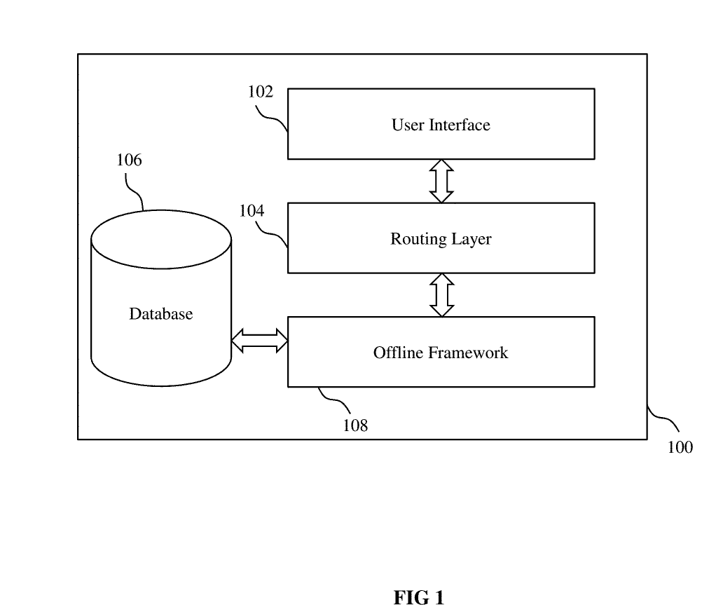

FIG. 1 is a block diagram of a system 100 for providing an offline framework for supporting insurance businesses in accordance with the embodiments of the present invention. In one embodiment of the present invention, the system 100 is implemented on a portable electronic device equipped with a display screen, a data storage and a computer processor. The portable electronic device includes but is not limited to an electronic notebook, an electronic notepad, a smartphone and a tablet device. The portable electronic device is accessed by a user who is an agent or representative of an insurance company. The user accesses the system 100 to demonstrate and/or sell one or more insurance business products to one or more end-users/customers or insured entities/parties who buy or want to buy the insurance products from the insurance companies. The system 100 comprises a dynamic user interface 102, a routing layer 104, a database 106 and an offline framework 108.

The dynamic user interface 102 is a configurable user interface that allows configuration of one or more user interface templates. Each user interface template is unique and defines the types of one or more menus, one or more input fields, and other materials required for the dynamic configuration of user interface 102. For example, one user interface template may contain one or more textboxes for inputting user data; another user interface template may provide one or more radio buttons, or various drop down menus, or date pickers and so on. In one embodiment of the present invention, one or more rules are predefined and are subsequently applied for dynamically configuring the user interface using the one or more user templates. The one or more predefined rules are based on various categories of one or more insurance business products provided by one or more insurance companies. The one or more insurance business products generally include but are not limited to life insurance products, general insurance products, health insurance products, travel insurance products, term insurance product, unit link insurance plan (ULIP) etcetera. The one or more predefined rules are further based on the geographical locations of the one or more end-users. In one embodiment of the present invention, the one or more predefined rules are stored and are updated from time to time so that any changes occurring in the insurance products due to current market trends and/or policies of the insurance companies are likewise reflected in the rules. The user interface 102 is therefore a dynamic interface that can be customized by the users based on their preferences, without having the need of being connected to the Internet. Also, the user interface 102 dynamically adjusts its aspect ratio for any screen size of the portable electronic device.

The routing layer 104 provides a link between the dynamic user interface 102 and the offline framework 108. The routing layer 104 serves as a medium to invoke one or more components of the insurance business products as well as other technical components from the offline framework 108. The routing layer 104 also functions as an event handler that handles the movement of control between different pages being rendered on the display screen of the portable electronic device. The routing 104 layer acts as a controlling and orchestrator layer. The routing layer 104 controls the invocation of the one or more predefined rules for executing calculations and business validations. If there are any validations errors, then the routing layer 104 sends feedback or alert to the user interface to notify the user. The routing layer 104 orchestrates different functionalities including but not limited to running business validations, calling/invoking the business calculation processes and eventually saving the data to an offline storage etcetera. Further, as explained above, the routing layer 104 controls the movement of different pages being rendered on the display screen of the portable electronic device, wherein the movement between pages are driven by various business scenarios. For example: any product details page can be opened only after mandatory personal details have been entered by the user; or a tabbed view may be enabled only after the user performs a particular action; or a page can be accessed only if the user is an authentic user who is authorized to gain the access of that page or who plays a specific or substantial role etcetera. All the above explained logics are configured using the routing layer 104.

The database 106 is an offline database that stores offline data pertaining to various insurance business components and products; credentials of the users; and collaterals like sales pitch document, information brochure, logo of the product, feature documents of the various insurance products. The data pertaining to the insurance products and their specifications or properties is stored in a list. The list is maintained in the database and can also be updated if there is any change in the insurance business products or policies. For example, information and specification of new insurance products, changes in the rates of the product, changes in the premium cost etcetera are required to be updated for carrying out accurate computation and calculations. In one embodiment of the present invention, the list can be updated manually whenever there is any change or modification in the insurance products. In another embodiment of the present invention the list can be updated after a fixed time interval, wherein the user may be prompted or alerted to carry out the updates from the server. Accordingly the user may connect the portable electronic device to the Internet, and download all the updates from the server.

Further, the database 106 is synchronized with the offline framework so as to offer the data as and when required, for carrying out complex calculation and computation pertaining to the insurance products. For example, user data, end-user data, profiles, rates, tenure, etcetera can be extracted from the database and can be provided to the offline framework to calculate the premiums for any end user for a given policy. The database also stores user data, the predefined rules, and templates that are required for the configuration of the dynamic user interface 102. Further, as explained above, the user can access the system 100 to demonstrate or sell the insurance products to the end-users. While accessing the system, the user may input various data of the end-user data such as end-user profiles, details of the insurance product selected by the end-user, details of the premiums to be paid for the selected product and other various transactional data. These data or user-inputs can also be saved in the database 106 in an offline mode without the need of connecting to the Internet. The offline stored data may later be used in association with various online insurance management tools being run through one or more web servers and web applications. When the user connects the portable electronic device to the internet, the system 100 gets synchronized with the online insurance management servers and tools, thereby transacting the data between the database 106 and the online web servers and applications.

The offline database 106 stores the details of insured party, beneficiaries, proposer and payer. The details include personal information of the end-user such as Name, Date of Birth, Gender, Occupation Details etcetera. The details may also include copies of various documents for example Passport, Driving License, Salary Certificate etc. These documents can be stored as scanned copies and images and can be used for verification and validation purposes. The offline database 106 also stores various lookup data like name of country, state, city, district and area.

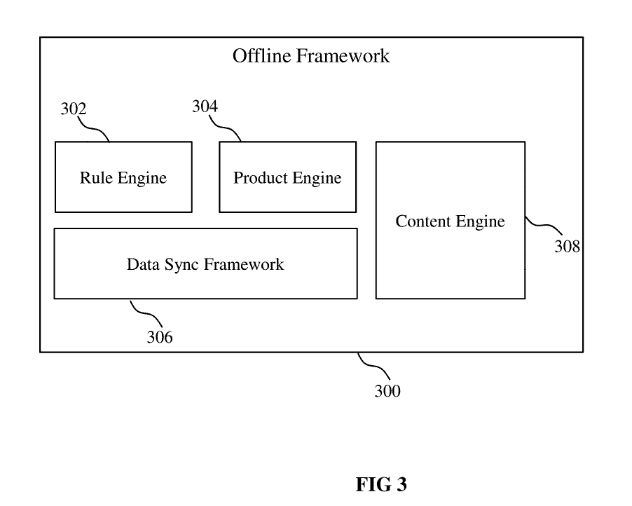

The offline framework 108 is a framework that supports insurance businesses by running complex calculations on the portable electronic device in an offline mode. The offline working mode of the offline framework 108 enables a user to reduce the average number of meetings required to close a deal with the end-users. In various embodiments of the present invention, the framework 108 enables the overall reduction in cost spent by the insurance companies. The offline framework 108 performs all the calculations and computation accurately at a high speed thus enabling the user to demonstrate the insurance products in very less time without the need of connecting to the internet or using paper based tools. This further helps in increasing business gains for the users and also for the insurance companies. Details of the offline framework 108 are discussed in the description of FIG. 3.

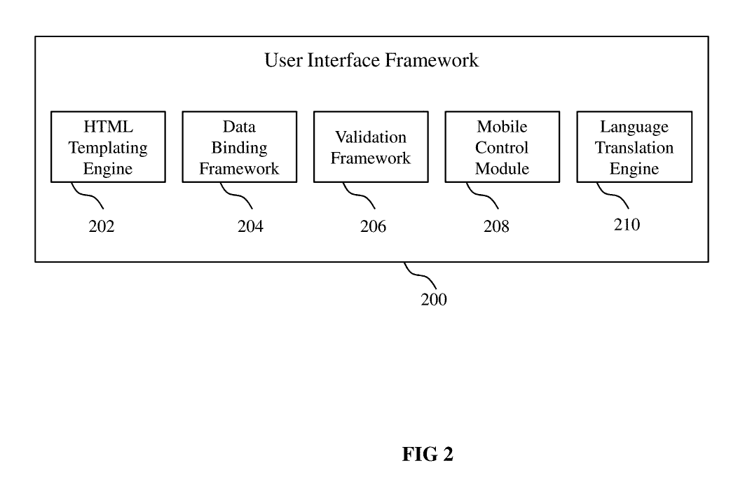

FIG. 2 is a block diagram of user interface in accordance with an embodiment of the present invention. The user interface 102 comprises an HTML templating engine 202, a data binding framework 204, a validation framework 206, a mobile control module 208, and a language translation engine 210.

The HTML templating engine 202 generates one or more user interface templates that are used in creating the offline user interface. The HTML templating engine 202 applies styles and themes to the one or more user interface templates and renders the same to the user for customization. Each user interface template is unique in design and orientation. Based on the various types of different insurance products, the user interface template defines the different menus, different input fields, and other materials required for the dynamic configuration of user interface 102.

The data binding framework 204 receives the customization inputs from the user and binds the same to generate a template or modify an existing template. The customization input includes the design, pattern, color scheme and themes of a user interface template. The data binding framework 204 simplifies the generation and modification of the user interface templates for a user.

The validation framework 206 authorizes the one or more users to access the offline framework via the electronic portable device. The validation framework 206 receives authorization details from the user trying to access the offline framework and validates the profile of the user for its authenticity. The validation framework 206 also provides restrictions on data inputs such as specific email format for email IDs, numeric characters for a contact number, etcetera fed by the user. For example if a user enters a wrong format of an email ID by missing out the “@” sign, the validation framework 206 will not allow the user to feed in a wrong format. It will restrict the user to input the email-id in the specific format only and will also prompt the user to correct it.

The mobile control module 208 comprises a plurality of user interface elements that allow a user to feed the inputs, select desired data for processing, perform customization based on his/her preferences, search for information, and provide customized output to the end-users. The plurality of user interface elements include but are not limited to one or more Drop Down Lists, Smart Table with Filtering options, Search Options, Drag-and-Drop components etcetera. Based on the context of end-user requirements and type of tasks to be performed (i.e. whether to capture users input or to show output to the end-user) various controls may be chosen. Some typical examples include usage of text box/text area for capturing user inputs like name, a Drop Down List would be used to show a list of available options to the end-user or customer, a year by year benefits or deductions would be represented using a smart table, a drag and drop control might be used to allowing the end-user to choose his family members or financial goals etc.

The language translation engine 210 provides support for different languages used by the end-users across the world. One or more language specific labels are predefined in the user interface template. The one or more language specific labels can be selected by the user to obtain a language specific user interface template. The language translation engine 210 also provides language translation of the information pertaining to the insurance business product as required by the end-users.

FIG. 3 is a block diagram illustrating elements of the offline framework 300 in accordance with an embodiment of the present invention. The offline framework 300 comprises a rule engine 302, a product engine 304, a data sync framework 306 and a content engine 308.

The rule engine 302 is a configurable module that enables the installation and execution of the offline framework on the portable electronic device. Further, one or more rules are predefined in the rule engine and the predefined rules are used to execute a plurality of complex calculations and computations pertaining to insurance business. These complex calculations and computations are performed in an offline mode by the rule engine, without requiring the need of an internet connection. The rule engine is designed such that it is capable of being executed on the portable electronic device that has limited memory space and limited hardware features. The rule engine is capable of performing high degree calculations and computations as it is a configurable module that includes a workbench for configuring and predefining the rules for performing the calculations as per the requirement of the user. The workbench is user friendly and enables the user to configure the rules using simple syntax constructions in an easy language such as English. Thus the user is capable of configuring rules based on his/her requirement and preferences. Further, the one or more predefined rules can be updated after specific time interval to accommodate any changes occurring in the insurance products and policies. For example there may be a change in the rate of calculating the insurance premium of a product. A typical insurance product involves thousands of complex calculations for that could change multiple time each year. Therefore any change in the premium rate, or in cost of the product can severely affect the entire calculation. In a scenario like this, the rule engine must be updated so that it can perform accurate calculations without any errors. The rule engine is updated based on the changes occurring in the current market trends and/or policies of the insurance companies. The rule engine can be updated when it is synchronized online with the help of insurance management servers and tools. This allows the rule engine to receive the updated data and information required for performing seamless computation and calculations.

The product engine 304 is a configurable module that is configured by an insurance company based on the various insurance business products launched or introduced by that company. As explained earlier, the various insurance business products include but are not limited to life insurance products, general insurance products, health insurance products, travel insurance products, term insurance product, unit link insurance plan (ULIP) etcetera. The product engine contains a workbench through which the product engine is configured by the insurance companies based on their various products. The product engine 304 defines metadata of each of the insurance business products. For example, the product engine provides information like product name, product code, rules defined for that product, tenure, rate of premium, cost of the product, sum insured, terms and conditions applicable etcetera. The product engine is in sync with other components of the offline framework to provide various data and information details based on the different kinds of products. For example, the product engine is in synchronization with the rule engine. The rule engine is therefore able to extract information from the product engine to perform complex calculations in an offline mode. In one embodiment of the present invention, the product engine can also be configured based on the geographical locations such as different countries and states. For example, different countries may define different rates for calculating the premium. The above-mentioned feature allows the product engine to perform country specific configuration of the product engine.

The data sync framework 306 is provided in the offline framework for performing synchronization between different components of the offline framework. The data synchronization framework 306 performs bi-directional synchronization of the components so that data can be exchanged to and fro between the components. Further, it also helps the synchronization of the offline framework with the remote servers and web applications of the insurance companies so that the components of the offline framework accommodate any changes, modifications and updates and allows users to seamlessly switch across devices.

The content engine 308 is provided for digitally publishing the contents. The content engine 308 contains digital content pertaining to various transactions and activities performed by the offline framework for supporting the insurance business support. In one embodiment of the invention, the content engine 308 synchronizes the digital content with the servers, and downloads the latest versions of the content for the users and end users to view in the offline mode. It helps in publishing the configurations of various modules or components of the offline framework, so that a user may be able to view the updates and configurations on the display screen without requiring Internet connection. Thus, the content engine enables a user to view in digital form, the content pertaining to one or more insurance business products. The content engine 308 also contains the content of the output or results of a deal between the user and the end-user and enables the user to digitally publish the output of the deal to the end users through a workbench. Thus the content engine 308 supports the publishing of configurations, updates, outputs and other content in digital form, thereby supporting over-the-air updates for rule, calculation, product metadata and other configuration changes.

The offline framework 300 thus analyzes user inputs in association with one or more predefined rules that are invoked from the offline database for performing complex computations and calculations in an offline mode without using an Internet connection.

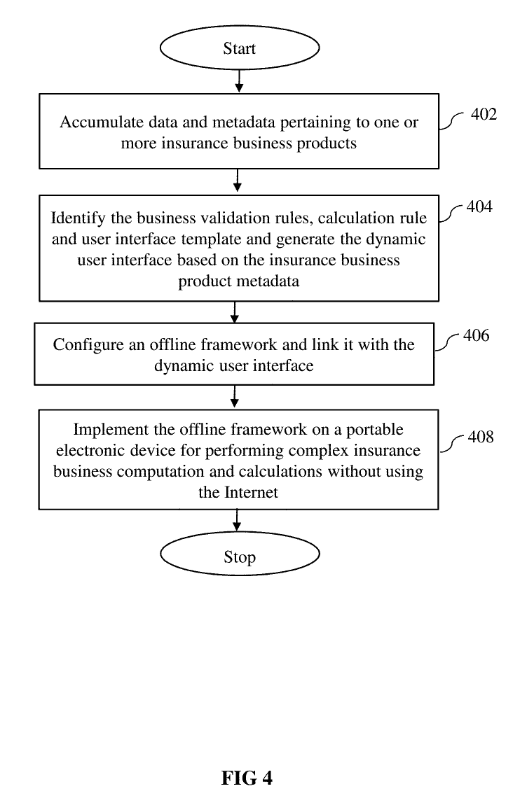

FIG. 4 is a flowchart illustrating method for providing an offline framework for supporting insurance businesses in accordance with an exemplary embodiment of the present invention.

At step 402, a plurality of data and metadata pertaining to one or more insurance business products provided by one or more insurance business companies are accumulated. The accumulated data and metadata pertains to one or more insurance business products that generally include but are not limited to life insurance products, general insurance products, health insurance products, travel insurance products, term insurance product, unit link insurance plan (ULIP) etcetera. The data also pertains to geographical location of one or more end-users who buy or want to buy one or more insurance business products from the one or more insurance business companies.

At step 404, one or more rules are predefined based on the data and the metadata and are subsequently applied for uniquely configuring one or more user interface templates. The one or more user interface templates are used to dynamically configure a user interface. The business validation rules, calculation rule and user interface template are identified and the dynamic user interface is generated based on the insurance business product metadata.

At step 406, an offline framework is configured and linked with the dynamically generated user interface. The user input & output template is chosen by the offline framework based on product metadata in offline database. The offline framework is linked with the user interface so as to invoke one or more components of the insurance business products as well as other technical components (Rule Engine, Offline Database, and Product Engine) from the offline framework to perform complex calculation via the dynamic user interface.

At step 408, the offline framework is implemented on a portable electronic device for performing complex insurance business computation and calculations, while responding to the user. User inputs are used along with the product rate data by the Rule Engine to perform the calculations. These complex computation and calculations are performed in an offline mode without requiring the need of an internet connection. The offline framework is capable of being executed on the portable electronic device that has limited memory space and limited hardware features. The result or output arising from the calculations and computations carried by the framework is digitally displayed to the end-users. Based on the product metadata the output display template is chosen by the routing logic and passed to dynamic user interface for output generation. The output data from Rule Engine is used by the dynamic user interface as data to be bound to the output template.

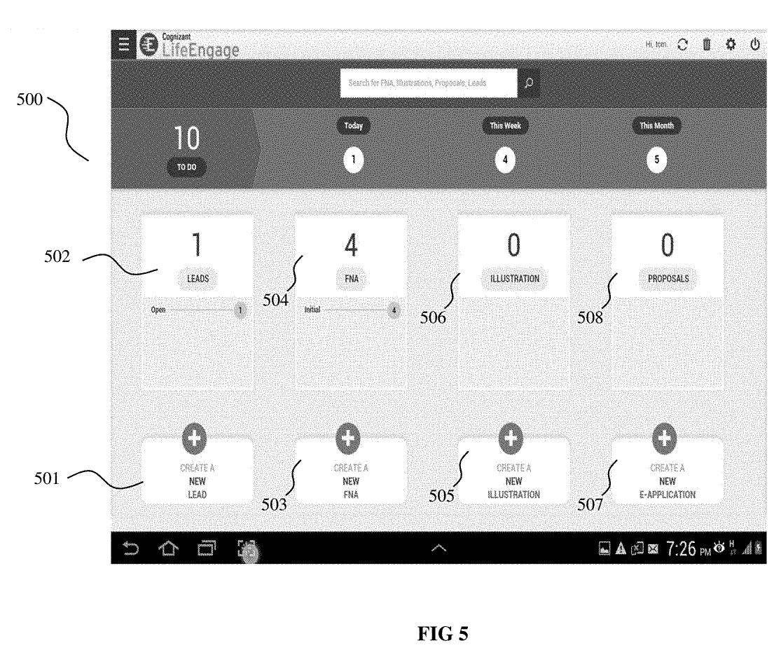

FIG. 5 shows one of the screenshots of the offline framework in accordance with an embodiment of the present invention. The screenshot 500 is an exemplary screenshot that is displayed on the portable electronic device for the user. The screenshot facilitates the user to demonstrate/sell the insurance business products to the customers by helping the user to carry out various tasks such as accumulating customer data, performing complex calculations etcetera. The screenshot 500 also depicts that provisions such as search engine is provided for facilitating a user to search data and information. Various information and data pertaining to leads; FNAs (Financial Need Analysis); illustrations; and proposals can be extracted using the search tool provided as shown in the figure. Also, as shown in the screenshot 500, provision for organizing one or more tasks, jobs, things-to-do or functionalities by the users on daily, weekly, or monthly basis, are also provided.

The screenshot 500 displays one or more icons. Icon 501 is provided for creating new leads of prospective customers. The details of leads are captured by accumulating customer information or end-user data such as end-user profile, name, address, contact number, email id etcetera. The icon 502 displays the total number of leads that are created and managed by the authorized user or insurance agent using the portable electronic device. Icon 503 is provided for creating one or more FNAs (Financial Need Analysis) of the leads/customers. Based on the requirements of the end-users, a user can create multiple FNAs for one lead. Accordingly, there may be several FNAs created for different users and the same can be viewed, edited, analyzed, processed and customized by the users according to the various needs of the customers/end-users. The Financial Need Analysis (FNA) is carried by the user/insurance-provider to understand the basic requirement of the customers with respect to the insurance protection sought. The Financial Need Analysis (FNA) facilitates the insurance providers/agents to obtain a detailed overview of financial condition of the prospective customers/end-users or leads. Icon 504 provides the total number of the FNAs created by the user and the status of the FNAs. Icon 505 and icon 506 are provided for respectively creating and managing one or more illustrations for the one or more leads or prospective customers. The illustrations pertains to the visual illustrations of various transactions and activities performed by the offline framework for supporting the insurance business support. The various transactions and activities may include, but are not limited to payment transactions, payment calculations, payment options, and premium calculations and computations etcetera. The illustrations may be provided by the content engine as explained above. The illustration icon 506 allows the users to view the updates and configurations on the display screen without requiring Internet connection. The icon 506 shows the total number of illustrations created by the user and their statuses. Icon 507 is provided for creating new e-applications for the one or more customers. The e-applications may contain customer proposals, scanned copies of the documents provided by the customers, documents proofs to certify the age, address, occupation, salaries, customer identities etcetera. Icon 508 provides the consolidated information like total count, their statuses and data of all customer proposals that can be used by the user and can be later sent for the process of underwriting and reviews.

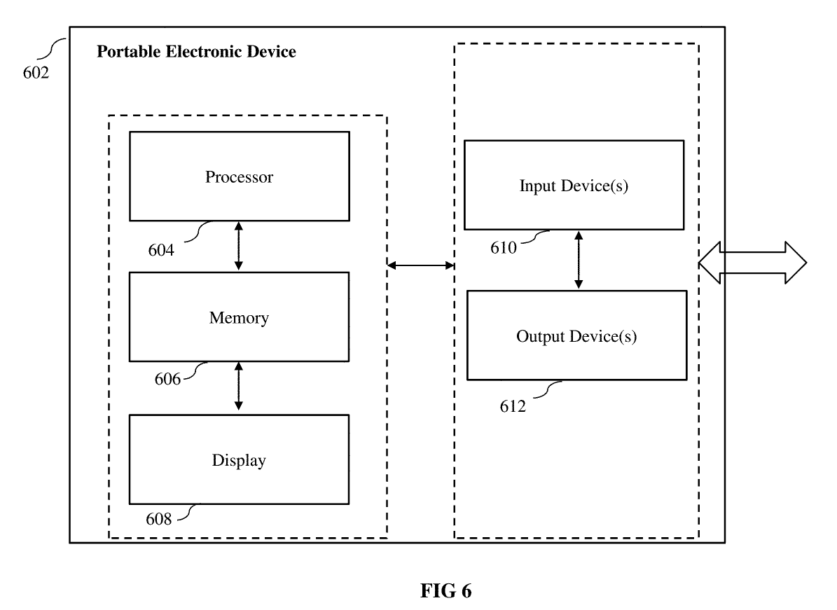

FIG. 6 illustrates an exemplary portable electronic device which can be used to implement various embodiments of the present invention.

The portable electronic device 602 comprises a processor 604, a memory 606, and a display 608. The processor 604 executes program instructions and may be a real processor and/or a virtual processor. The portable electronic device 602 is not intended to suggest any limitation as to scope of use or functionality of described embodiments. For example, the portable electronic device 602 may include, but is not limited to an electronic notebook, an electronic notepad, a smartphone and a tablet device, and other devices or arrangements of devices that are capable of implementing the steps that constitute the method of the present invention. In an embodiment of the present invention, the memory 606 may store software for implementing various embodiments of the present invention. In various embodiments of the present invention, operating system software provides an operating environment for various processes being executed in the portable electronic device 602, and manages different functionalities of the components of the portable electronic device 602.

The portable electronic device 602 may receive input via input device(s) 610 such as, a keyboard, mouse, pen, joystick, trackball, a voice device, a scanning device, or any another device that is capable of providing input to the portable electronic device 602. In an embodiment of the present invention, the input device(s) 610 may be a sound card or similar device that accepts audio input in analog or digital form. In addition to the display 608, the output may be provided using one or more output device(s) 612 such as a speaker or any other device that provides output from the portable electronic device 602.

The memory 606 may include drives or any other medium which can be used to store information and can be accessed by the portable electronic device 602. In various embodiments of the present invention, the memory 606 contains program instructions for implementing the described embodiments.

The present invention may suitably be embodied as a computer program product for use with a computer system. The computer program product may comprise a set of program instructions which is executed by the computer system or any other similar device. The set of program instructions may be a series of computer readable codes stored on a tangible medium, such as a computer readable storage medium, for example, diskette, CD-ROM, ROM, flash drives or hard disk, or transmittable to the computer system. These instructions can be preloaded into a system or recorded on a storage medium such as a CD-ROM, or made available for downloading over a network such as the internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A system for supporting insurance business in an offline mode, the system comprising:
one or more processors executing program instructions stored in one or more storage devices, at least one processor of the one or more processors configuring:
a dynamic user interface based on one or more user interface templates, one or more predefined rules, and user preferences, wherein the dynamic user interface receives user inputs from one or more users;
a database for storing the one or more user interface templates, the one or more predefined rules, and data pertaining to one or more insurance business products;
an offline framework in synchronization with the dynamic user interface and the offline database, the offline framework analyzing the user inputs and invoking the one or more predefined rules for executing one or more complex computations and calculations for insurance business support.

2. The system of claim 1, wherein each of the one or more user interface templates is unique having one or more menus and one or more input fields for customizing the dynamic user interface.

3. The system of claim 1, wherein one or more predefined rules are based on the one or more insurance business products.

4. The system of claim 1, wherein the one more predefined rules are based on the geographical locations of one or more end-users of the one or more insurance business products.

5. The system of claim 1, wherein the database is updated based on any changes occurring in insurance business domain.

6. The system of claim 5, wherein the database is updated randomly or after a fixed interval of time.

7. The system of claim 1, further comprising a routing layer for providing a link between the dynamic user interface and the offline framework.

8. The system of claim 1, wherein the dynamic user interface comprises an HTML templating engine for generating the one or more user interface templates.

9. The system of claim 1, wherein the dynamic user interface comprises a validation framework for authorizing one or more users to access the offline framework.

10. The system of claim 1, wherein the dynamic user interface comprises a language translation engine for providing language translation support.

11. The system of claim 1, wherein the offline framework comprises a rule engine for generating the one or more predefined rules.

12. The system of claim 1, wherein the offline framework comprises a product engine for providing the data pertaining to the one or more insurance business products.

13. The system of claim 1, wherein the offline framework comprises a data sync framework for providing synchronization between one or more components of the offline framework.

14. The system of claim 1, wherein the offline framework comprises a content engine for facilitating digital publication of content in an offline mode.

15. A computer-implemented method for supporting insurance business in an offline mode, the method comprising the steps of:
executing via one or more processors, program instructions stored in one or more storage devices for:
configuring a dynamic user interface based on one or more user interface templates, one or more predefined rules, and user preferences, wherein the dynamic user interface receives user inputs from one or more users;
storing in a database the one or more user interface templates, the one or more predefined rules, and data pertaining to one or more insurance business products; and
configuring an offline framework in synchronization with the dynamic user interface and the offline database, the offline framework analyzing the user inputs and invoking the one or more predefined rules for executing one or more complex computations and calculations for insurance business support.

16. The computer-implemented method of claim 15, wherein each of the one or more user interface templates is configured uniquely by providing one or more menus and one or more input fields for customizing the dynamic user interface.

17. The computer-implemented method of claim 15, wherein one or more predefined rules are predefined based on the one or more insurance business products.

18. The computer-implemented method of claim 15, wherein the one more predefined rules are predefined based on the geographical locations of one or more end-users of the one or more insurance business products.

19. The computer-implemented method of claim 15, wherein the database is updated based on any changes occurring in insurance business domain.

20. The computer-implemented method of claim 19, wherein the database is updated randomly or after a fixed interval of time.

21. The computer-implemented method of claim 15, further configuring a routing layer for providing a link between the dynamic user interface and the offline framework.

22. The computer-implemented method of claim 15, wherein the dynamic user interface is configured to provide an HTML templating engine for generating the one or more user interface templates.

23. The computer-implemented method of claim 15, wherein the dynamic user interface is configured to provide a validation framework for authorizing one or more users to access the offline framework.

24. The computer-implemented method of claim 15, wherein the dynamic user interface is configured to provide a language translation engine for providing language translation support.

25. The computer-implemented method of claim 15, wherein the offline framework is configured to provide a rule engine for generating the one or more predefined rules.

26. The computer-implemented method of claim 15, wherein the offline framework is configured to provide a product engine for providing the data pertaining to the one or more insurance business products.

27. The computer-implemented method of claim 15, wherein the offline framework is configured to provide a data sync framework for providing synchronization between one or more components of the offline framework.

28. The computer-implemented method of claim 15, wherein the offline framework is configured to provide a content engine for facilitating digital publication of content in an offline mode.
